(19) United States
(12) Patent Application Publication
(10) Pub. No.: US 2026/0175830 A1
(43) Pub. Date: Jun. 25, 2026

(54) IN-VEHICLE APPARATUS

(71) Applicant: SUBARU CORPORATION, Tokyo (JP)

(72) Inventors: Junichi MOTOYAMA, Tokyo (JP); Yuto AOKI, Tokyo (JP); Tsukasa MIKUNI, Tokyo (JP); Ryota NAKAMURA, Tokyo (JP)

(21) Appl. No.: 18/729,334

(22) PCT Filed: Mar. 30, 2023
(86) PCT No.: PCT/JP2023/013235

§ 371 Date: Jul. 16, 2024

(51) Int. Cl. B60W 20/12; B60W 30/14; B60W 30/16; B60W 30/182; B60W 40/08; G01C 21/34

(52) U.S. Cl. CPC B60W 20/12; B60W 30/143; B60W 30/16; B60W 30/182; B60W 40/08; G01C 21/3461; G01C 21/3469; B60W 2040/0881; B60W 2540/227; B60W 2554/802; B60W 2555/60; B60W 2556/40; B60W 2556/50

(57) ABSTRACT

An in-vehicle apparatus includes a navigator that acquires a current position of an own vehicle and guides the own vehicle along a traveling route, an area information extractor that extracts a communication difficulty area, a vehicle controller that performs traveling auxiliary control on the own vehicle, and a travel information manager that determines a communication state in a traveling direction of the own vehicle and transmits travel information on the own vehicle to the vehicle controller. When the travel information manager determines that the communication difficulty area is located in the traveling direction of the own vehicle, the travel information manager switches a traveling mode to a power-saving traveling mode, and the vehicle controller stops map information from being updated via communication and performs the traveling auxiliary control based on the map information acquired before the entry of the own vehicle into the communication difficulty area.

### TECHNICAL FIELD

The invention relates to an in-vehicle apparatus.

### BACKGROUND ART

In recent years, charging stations for electric vehicles have been popularized with the popularization of electric vehicles.

However, a sufficient number of charging stations for electric vehicles has not been secured yet, and there is a possibility that an own vehicle becomes difficult to travel due to a shortage of charging before reaching a charging station. Therefore, position information on charging stations is to be acquired in advance before traveling in an electric vehicle.

To address this concern, a power-saving driver assistance apparatus that reduces electric power consumption of an electric vehicle is disclosed in, for example, Patent Literature 1. The power-saving driver assistance apparatus includes an electric power consumption acquiring unit that acquires a power amount consumed by the electric vehicle per unit traveling distance, a residual capacity acquiring unit that acquires a residual capacity of a storage battery, a station distance acquiring unit that acquires a traveling distance from a current position to a charging station, a possible traveling distance calculating unit that calculates a distance that the electric vehicle is able to travel with the residual capacity based on the electric power consumption acquired by the electric power consumption acquiring unit and the residual capacity acquired by the residual capacity acquiring unit, and a power-saving necessity display unit that displays the possible traveling distance calculated by the possible traveling distance acquiring unit and the traveling distance to the charging station acquired by the station distance acquiring unit.

### CITATION LIST

### Patent Literature

Patent Literature 1: Japanese Unexamined Patent Application Publication No. 2009-171647

### SUMMARY OF INVENTION

### Problem to be Solved by the Invention

With the development in technology relating to driver assistance and automated driving, map information used for the driver assistance and the automated driving is having enormous data capacity as compared with map information for simple map display used in a navigation device or the like. Due to the increase in the data capacity, the map information for the driver assistance and the automated driving is stored in a server or the like, and a vehicle-side component downloads and uses the map information or the like as map data from the server, as necessary.

With such a configuration, it is difficult to download the map information from the server in some cases when an own vehicle enters an area in which communication is difficult to be established.

According to the technique disclosed in Patent Literature 1, a traveling distance is calculated based on the acquired map information, and a possible traveling distance is calculated based on a residual capacity of a storage battery.

Therefore, when the own vehicle enters the area in which communication is difficult to be established, it is difficult to calculate the traveling distance to a charging station. This raises a problem that the residual capacity of a vehicle traveling battery of the own vehicle becomes insufficient.

The invention has been made in view of the above-described problem, and an object of of the invention is to provide an in-vehicle apparatus that reduces the electric power consumption of a vehicle traveling battery without making an occupant feel strange even when an own vehicle enters an area in which communication is difficult to be established.

### Means for Solving the Problem

Aspect 1: One or more embodiments of the invention propose an in-vehicle apparatus including a navigator, an area information extractor, a vehicle controller, and a travel information manager. The navigator is configured to acquire a current position of an own vehicle, provides map information on surroundings of the current position of the own vehicle, and guide the own vehicle along a determined traveling route. The area information extractor is configured to extract an area in which a communication state is deteriorated. The area is included in the map information. The vehicle controller is configured to perform traveling auxiliary control comprising automated driving in which a driving operation to drive the own vehicle is to be performed primarily by the own vehicle or driver assistance in which a driving operation primarily performed by a driver is to be assisted. The travel information manager is configured to determine the communication state in a traveling direction of the own vehicle based on information received from the area information extractor and transmits travel information on the own vehicle to the vehicle controller based on a traveling mode selected in the vehicle controller. The travel information manager is configured to, when the travel information manager determines that the own vehicle is to travel in the area in which the communication state is deteriorated or that the area in which the communication state is deteriorated is located on the determined traveling route, transmit, to the vehicle controller, information indicating that the traveling mode is to be switched to a power-saving traveling mode in which electric power consumption of an electrical device in the own vehicle is reduced. The vehicle controller is configured to switch the traveling mode to the power-saving traveling mode, stop the map information for the traveling auxiliary control from being updated via communication, and perform the traveling auxiliary control based on the map information acquired before entry of the own vehicle into the area in which the communication state is deteriorated.

Aspect 2: One or more embodiments of the invention propose the in-vehicle apparatus in which, when the own vehicle travels in the area in which the communication state is deteriorated with the power-saving traveling mode being selected, the travel information manager causes the navigator and the vehicle controller to set the traveling route on which acceleration and deceleration control on the own vehicle is less likely to be performed in view of undulations of the traveling route and the number of traffic lights on the traveling route.

Aspect 3: One or more embodiments of the invention propose the in-vehicle apparatus in which the own vehicle further includes an inter-vehicular distance sensor that acquires an inter-vehicular distance to a preceding vehicle traveling in front of the own vehicle. When the own vehicle travels in the area in which the communication state is deteriorated with the power-saving traveling mode being selected, the travel information manager transmits, to the vehicle controller, information indicating that a normal following traveling mode is to be switched to a power-saving following traveling mode. The normal following traveling mode is a mode in which the own vehicle travels following the preceding vehicle while maintaining a constant inter-vehicular distance based on information received from the inter-vehicular distance sensor, and the power-saving following traveling mode is a mode in which the own vehicle travels following the preceding vehicle while maintaining a longer inter-vehicular distance than the inter-vehicular distance in the normal following traveling mode. The vehicle controller performs control to maintain the inter-vehicular distance by performing gradual acceleration and deceleration control upon following the preceding vehicle.

Aspect 4: One or more embodiments of the invention propose the in-vehicle apparatus further including a seating sensor that detects a position in which an occupant of the own vehicle is seated. When the own vehicle travels in the area in which the communication state is deteriorated with the power-saving traveling mode being selected, the travel information manager transmits, to the vehicle controller, information indicating that an air flow of an air conditioner toward a seat in which no occupant is seated is to be reduced or stopped.

Aspect 5: One or more embodiments of the invention propose an in-vehicle apparatus includes one or more processors and one or memories communicably coupled to the one or more processors. The one or more memories include a recording unit that records map information on routes and information on an area in which a communication state is deteriorated. The one or more processors include a navigator, an area information extractor, a vehicle controller, and a travel information manager. The navigator is configured to acquire a current position of an own vehicle, provide map information on surroundings of the current position of the own vehicle, and guide the own vehicle along a determined traveling route. The area information extractor is configured to extract the area in which the communication state is deteriorated. The area is included in the map information. The vehicle controller is configured to perform traveling auxiliary control comprising automated driving in which a driving operation to drive the own vehicle is to be performed primarily by the own vehicle or driver assistance in which a driving operation primarily performed by a driver is to be assisted. The travel information manager is configured to determine the communication state in a traveling direction of the own vehicle based on information received from the area information extractor, manages travel information on the own vehicle based on a traveling mode selected in the vehicle controller, and transmits the travel information to the vehicle controller based on a request from the vehicle controller. The travel information manager is configured to, when the travel information manager determines that the own vehicle is to travel in the area in which the communication state is deteriorated or that the area in which the communication state is deteriorated is located on the determined traveling route, transmit, to the vehicle controller, information indicating that the traveling mode is to be switched to a power-saving traveling mode in which electric power consumption of an electrical device in the own vehicle is reduced. The vehicle controller is configured to switch the traveling mode to the power-saving traveling mode, stops the map information for the traveling auxiliary control from being updated via communication, and performs the traveling auxiliary control based on the map information acquired before entry of the own vehicle into the area in which the communication state is deteriorated.

### Effect of the Invention

According to one or more embodiments of the invention, it is possible to reduce the electric power consumption of the vehicle traveling battery without making the occupant feel strange even when the own vehicle enters the communication difficulty area.

### BRIEF DESCRIPTION OF DRAWINGS

FIG. 1 is a diagram illustrating a configuration of a vehicle control system according to a first embodiment of the invention.

FIG. 2 is a diagram illustrating a configuration of an in-vehicle apparatus according to the first embodiment of the invention.

FIG. 3 is a diagram illustrating a traveling route of an own vehicle including the in-vehicle apparatus according to the first embodiment of the invention.

FIG. 4 is a flowchart of a process performed by the in-vehicle apparatus according to the first embodiment of the invention.

FIG. 5 is a diagram illustrating a configuration of a vehicle traveling system according to a second embodiment of the invention.

FIG. 6 is a diagram illustrating a configuration of an in-vehicle apparatus according to the second embodiment of the invention.

FIG. 7 is a flowchart of a process performed by the in-vehicle apparatus according to the second embodiment of the invention.

FIG. 8 is a diagram illustrating a configuration of a vehicle control system according to a third embodiment of the invention.

FIG. 9 is a diagram illustrating a configuration of an in-vehicle apparatus according to the third embodiment of the invention.

FIG. 10 is a flowchart of a process performed by the in-vehicle apparatus according to the third embodiment of the invention.

### MODES FOR CARRYING OUT THE INVENTION

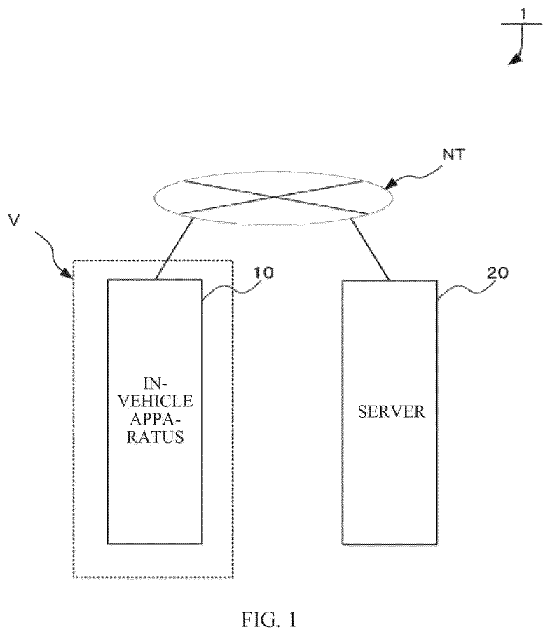

A vehicle control system 1 according to some embodiments will now be described with reference to FIGS. 1 to 10.

In the following description, an own vehicle V is an electric vehicle that travels using a vehicle traveling battery BT.

### First Embodiment

The vehicle control system 1 according to a first embodiment will now be described with reference to FIGS. 1 to 4.

### <Vehicle Control System 1

As illustrated in FIG. 1, the vehicle control system 1 according to the first embodiment includes an in-vehicle apparatus 10 and a server 20.

The in-vehicle apparatus 10 controls an overall operation of the vehicle control system 1 based on a control program stored in a read-only memory (ROM) mounted in the in-vehicle apparatus 10.

Further, when it is determined that the own vehicle V is to travel in a communication difficulty area WR or that the communication difficulty area WR is located on a traveling route RA, the in-vehicle apparatus 10 performs traveling auxiliary control DA in which a traveling mode DM is switched to a power-saving traveling mode ED and updating map information MI via communication is stopped, for example.

Details of the in-vehicle apparatus 10 will be described later.

The server 20 is provided outside the own vehicle V, and stores, for example, data such as the map information MI, surrounding area information, and traffic congestion information to be used in driver assistance control or automated driving control. The server 20 and the in-vehicle apparatus 10 are coupled to each other by wireless communication via a communication network NT such as a wireless communication base station, for example.

The server 20 transmits the data to the in-vehicle apparatus 10 based on a request from the in-vehicle apparatus 10.

### <In-Vehicle Apparatus 10>

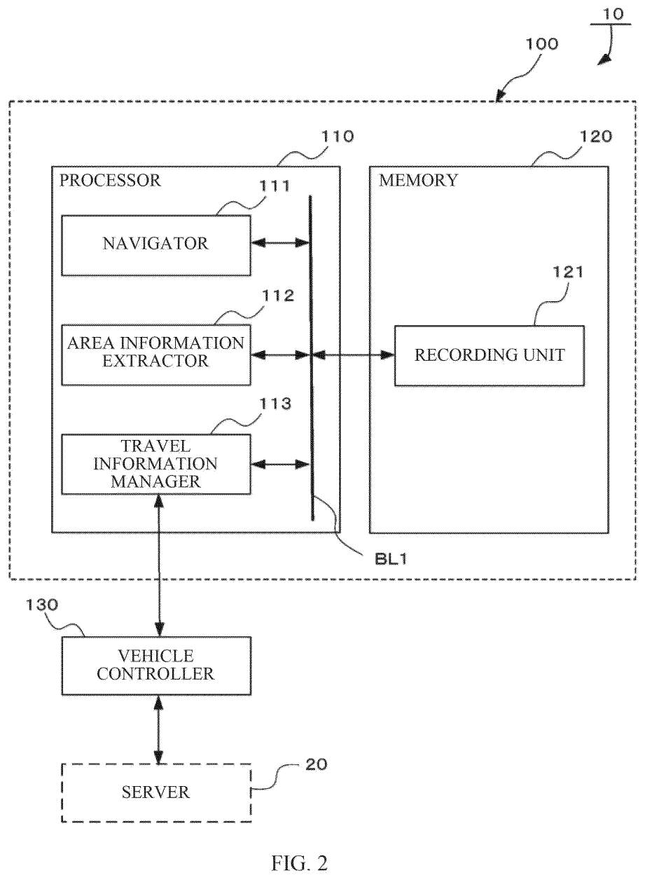

As illustrated in FIG. 2, the in-vehicle apparatus 10 includes a processor unit 100 and a vehicle controller 130.

<Configuration of Processor unit 100>

The processor unit 100 includes a processor 110 and a memory 120. The processor unit 100 controls an overall operation of the in-vehicle apparatus 10 based on a control program stored in a read-only memory (ROM) included in the memory 120.

The processor 110 includes a navigator 111, an area information extractor 112, and a travel information manager 113. The memory 120 includes a recording unit 121.

The navigator 111, the area information extractor 112, and the travel information manager 113 in the processor 110, and the memory 120 are coupled to each other via a bus line BL1.

The navigator 111 guides the own vehicle V along the traveling route RA serving as determined route information. In other words, the navigator 111 sets the traveling route RA from a current position of the own vehicle V to a destination based on the map information MI and traffic information TI received from the server 20, and guides the own vehicle V to the destination.

In addition, the navigator 111 includes, for example, a global positioning system (GPS) receiver to detect the current position of the own vehicle V based on electric waves received from the GPS satellites. The information on the current position of the own vehicle V identified by the navigator 111 is transmitted to the area information extractor 112 and the travel information manager 113 via the bus line BL1.

In addition, the navigator 111 acquires traveling route information RI on the current position of the own vehicle V, the traveling route RA, a traveling distance, a traveling speed, and the like from the map information MI and the traffic information TI, and transmits the traveling route information RI to the travel information manager 113 via the bus line BL1.

The area information extractor 112 extracts the communication difficulty area WR located in a traveling direction of the own vehicle V or included in the traveling route RA from the map information MI.

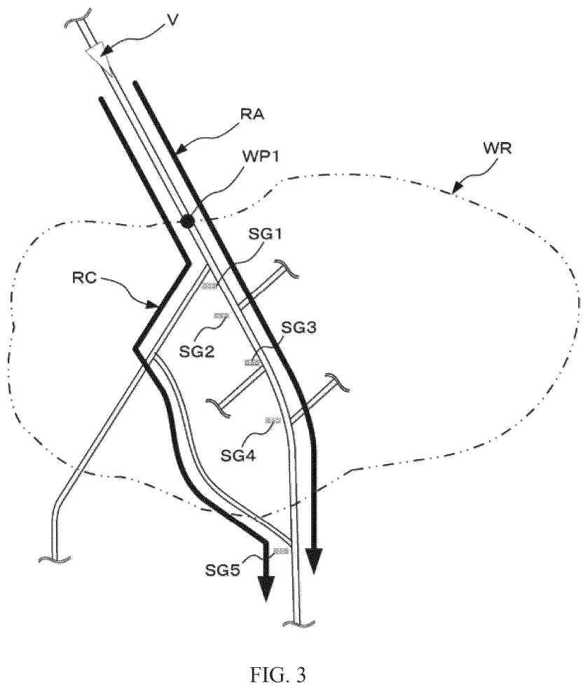

As illustrated in FIG. 3, when the communication difficulty area WR is included in the map information MI acquired from the server 20, the area information extractor 112 extracts the communication difficulty area WR from the map information MI, and transmits information on the communication difficulty area WR to the travel information manager 113 via the bus line BL1.

The area information extractor 112 extracts the communication difficulty area WR by acquiring the electric field strength of an electric wave used for the wireless communication with the server 20 from the vehicle controller 130 to be described later.

Specifically, the area information extractor 112 acquires, for example, electric field strength information on transmission/reception electric waves or error rate information on communication data from the vehicle controller 130.

The area information extractor 112 determines whether the electric field strength information or the error rate information is greater than or equal to a predetermined value of the electric field strength or a predetermined value of the error rate of the communication data stored in advance in the memory 120. Thereafter, the area information extractor 112 transmits a determination result to the travel information manager 113.

When the electric field strength information or the error rate information that is greater than or equal to the predetermined value becomes less than the predetermined value, the area information extractor 112 transmits information indicating that the own vehicle V has entered the communication difficulty area WR to the travel information manager 113.

When the electric field strength information or the error rate information that is less than the predetermined value becomes greater than or equal to the predetermined value, the area information extractor 112 transmits information indicating that the own vehicle V has passed through the communication difficulty area WR to the travel information manager 113.

Based on the information received from the area information extractor 112, the travel information manager 113 determines a communication state TS in the traveling direction of the own vehicle V, manages travel information DI on the own vehicle V based on a selected traveling mode MD, and transmits the travel information DI to the vehicle controller 130 in response to a request from the vehicle controller 130.

In addition, when determining that the own vehicle V is to travel in the communication difficulty area WR in which the communication state is deteriorated or that the communication difficulty area WR is located on the determined traveling route RA, the travel information manager 113 transmits, to the vehicle controller 130, information indicating that the traveling mode DM is to be switched to the power-saving traveling mode ED in which the electric power consumption of an electrical device in the own vehicle V is reduced.

Specifically, the travel information manager 113 acquires, for example, the traveling route information RI received from the navigator 111, and vehicle control information on a traveling battery residual amount of the own vehicle V, a possible traveling distance corresponding to the traveling battery residual amount, and the like, received from the vehicle controller 130, as the travel information DI, and stores the travel information DI in the memory 120.

Thereafter, the travel information manager 113 transmits the travel information DI to the vehicle controller 130 in response to a request from the vehicle controller 130.

In addition, as illustrated in FIG. 3, the travel information manager 113 determines whether the own vehicle V has entered the communication difficulty area WR at a communication difficulty area entrance point WP1 on the traveling route RA of the own vehicle V, for example, based on the information received from the area information extractor 112.

When the own vehicle V enters the communication difficulty area WR, the travel information manager 113 transmits the information indicating that the traveling mode DM is to be switched to the power-saving traveling mode ED to the vehicle controller 130.

When the own vehicle V travels in the communication difficulty area WR with the power-saving traveling mode ED being selected, the travel information manager 113 causes the navigator 111 to set a power-saving traveling route RE in view of undulations of the determined traveling route RA and the number of traffic lights on the traveling route RA. The power-saving traveling route RE is a traveling route on which acceleration/deceleration control of the own vehicle V is less likely to be performed.

Specifically, when determining that the own vehicle V has entered the communication difficulty area WR with the power-saving traveling mode ED being selected, the travel information manager 113 acquires the traveling route information RI on traveling distances of multiple potential traveling routes, undulations of the potential traveling routes, the number of traffic lights on the potential traveling routes, and the like from the navigator 111.

Thereafter, the travel information manager 113 selects the power-saving traveling route RE on which the acceleration/deceleration control of the own vehicle V is less likely to be performed based on the traveling route information RI, and transmits information indicating that the traveling route RA is to be switched to the power-saving traveling route RE to the navigator 111.

More specifically, as illustrated in FIG. 3, the travel information manager 113 compares the traveling route information RI between the traveling route RA and a traveling route RC that are included in the multiple potential traveling routes, for example.

For example, the travel information manager 113 determines that there are five traffic lights SG1 to SG5 on the traveling route RA, and that there are two traffic lights SG1 and SG5 on the traveling route RC.

Thereafter, the travel information manager 113 selects the traveling route RC having a fewer number of the traffic lights as the power-saving traveling route RE in view of the traveling distances and the undulations on the traveling routes, and transmits the information on the switch to the power-saving traveling route RE to the navigator 111.

Further, when receiving the information indicating that the own vehicle V has passed through the communication difficulty area WR from the area information extractor 112, the travel information manager 113 transmits the information indicating that the own vehicle has passed through the communication difficulty area WR to the vehicle controller 130.

The vehicle controller 130 performs the traveling auxiliary control DA such as automated driving in which a driving operation is to be performed primarily by the own vehicle V or driver assistance in which a driving operation primarily performed by a driver is to be assisted, for example.

Specifically, the vehicle controller 130 performs the traveling auxiliary control DA such as the automated driving or the driver assistance based on the travel information DI received from the travel information manager 113, for example.

Herein, the traveling auxiliary control DA refers to control performed by the vehicle controller 130 to assist traveling of the own vehicle V. For example, the traveling auxiliary control DA is control of the own vehicle V, such as control to accelerate or decelerate a traveling speed, adjust an electrical device such as an air conditioner or an illumination device, monitor a traveling lane, maintain an inter-vehicular distance, and maintain a traveling speed.

Further, the vehicle controller 130 reduces the electric power consumption of the vehicle traveling battery by automatically stopping the map information MI for the automated driving control or the driver assistance control from being updated via the communication.

Thereafter, the vehicle controller 130 performs the traveling auxiliary control DA based on the map information MI acquired before the entry of the own vehicle V into the communication difficulty area WR.

The vehicle controller 130 switches the traveling mode DM of the own vehicle V based on the information received from the travel information manager 113.

Specifically, when receiving the information indicating that the own vehicle V has entered the communication difficulty area WR and that the traveling mode MD is to be switched to the power-saving traveling mode ED from the travel information manager 113, the vehicle controller 130 automatically switches the traveling mode DM of the own vehicle V to the power-saving traveling mode ED.

The vehicle controller 130 has multiple traveling modes in which the electric power consumption is reduced as the traveling modes DM.

For example, the vehicle controller 130 has a normal traveling mode ND and the power-saving traveling mode ED as the traveling mode DM.

Herein, the normal traveling mode ND refers to a mode in which the control of the own vehicle V is performed in accordance with a setting set by an occupant.

The power-saving traveling mode ED is a mode in which the electric power consumption is further reduced than in the normal traveling mode ND.

Specifically, in the power-saving traveling mode ED, the electric power consumption of an electrical device such as an air conditioner, an audio device, or an illumination device disposed in the own vehicle V is reduced.

More specifically, in the power-saving traveling mode ED, control to reduce the electric power consumption of the air conditioner is performed by changing a temperature setting and an air flow, for example.

In addition, in the power-saving traveling mode ED, the electric power consumption of the illumination device is reduced by lowering the illumination level of the illumination device disposed in the own vehicle V.

When receiving the information indicating that the own vehicle V has passed through the communication difficulty area WR from the travel information manager 113, the vehicle controller 130 switches the power-saving traveling mode ED to the traveling mode DM having been selected before the entry of the own vehicle V into the communication difficulty area WR.

The vehicle controller 130 is provided with a non-illustrated in-vehicle communicator. The in-vehicle communicator communicates with the server 20 via a communication network NT under the control by the vehicle controller 130. The in-vehicle communicator acquires the electric field strength information on the transmission/reception electric wave for the wireless communication or the error rate information on the communication data.

The vehicle controller 130 transmits the acquired electric field strength information on the transmission/reception electric wave for the wireless communication or the acquired error rate information on the communication data to the area information extractor 112.

### <Process in In-Vehicle Apparatus 10>

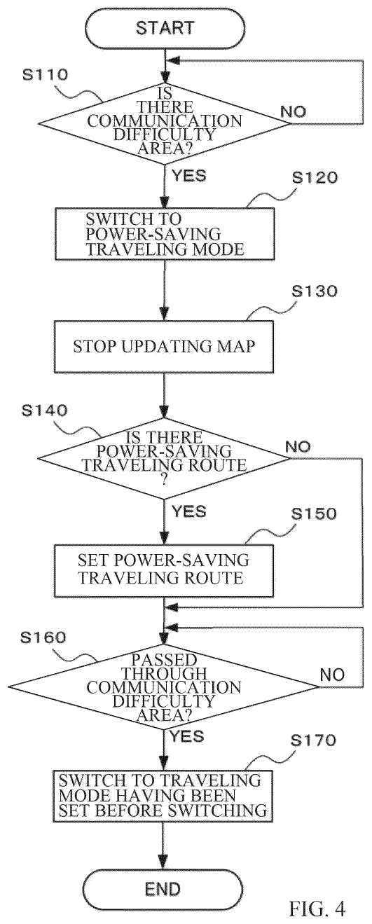

An exemplary process performed by the in-vehicle apparatus 10 according to the first embodiment will now be described with reference to FIG. 4.

The travel information manager 113 determines whether the communication difficulty area WR is located in the travel direction of the own vehicle V or on the traveling route RA based on the information received from the area information extractor 112 (Step S110).

When determining that the communication difficulty area WR is not located on the traveling route RA or in the traveling direction of the own vehicle V (Step S110: NO), the travel information manager 113 causes the process to transit to Step S110.

In contrast, when determining that the communication difficulty area WR is located in the traveling direction of the own vehicle V or on the traveling route RA (Step S110: YES), the travel information manager 113 transmits the information indicating that the traveling mode DM is to be switched to the power-saving traveling mode ED to the vehicle controller 130. Based on the information received from the travel information manager 113, the vehicle controller 130 switches the control in the traveling mode MD to the control in the power-saving traveling mode ED (Step S120), and the travel information manager 113 causes the process to transit to Step S130.

Further, the vehicle controller 130 stops the map information from being updated via the communication, and starts the traveling auxiliary control DA based on the map information MI acquired before the entry of the own vehicle V into the communication difficulty area WR (Step S130).

The travel information manager 113 acquires the traveling route information RI on the multiple potential traveling routes from the navigator 111, and determines whether it is possible to select the power-saving traveling route RE (Step S140).

When determining that it is difficult to select the power-saving traveling route RE (Step S140: NO), the travel information manager 113 causes the process to transit to Step S160 without making a switch to the traveling route RA.

In contrast, when determining that it is possible to select the power-saving traveling route RE (Step S140: YES), the travel information manager 113 transmits the information indicating that the traveling route RA is to be switched to the power-saving traveling route RE to the navigator 111 and the vehicle controller 130, and the navigator 111 sets the power-saving traveling route RE.

Thereafter, based on the information received from the travel information manager 113, the vehicle controller 130 switches the vehicle control to the power-saving traveling route RE (Step S150).

Thereafter, the travel information manager 113 determines whether the own vehicle V has passed through the communication difficulty area WR based on the information received from the area information extractor 112 (Step S160).

When determining that the own vehicle V has not passed through the communication difficulty area WR (Step S160: NO), the travel information manager 113 causes the process to transit to Step S160.

In contrast, when determining that the own vehicle V has passed through the communication difficulty area WR (Step S160: YES), the travel information manager 113 transmits the information indicating that the own vehicle V has passed through the communication difficulty area WR to the vehicle controller 130, and causes the process to transit to Step S170.

Based on the information received from the travel information manager 113, the vehicle controller 130 switches the power-saving traveling mode ED to the traveling mode DM having been selected before the entry of the own vehicle V into the communication difficulty area WR (Step S170), and the travel information manager 113 terminates the process.

### <Workings and Effects>

As described above, the in-vehicle apparatus 10 according to the first embodiment includes the navigator 111, the area information extractor 112, the vehicle controller 130, and a travel information manager 113. The navigator 111 acquires a current position of the own vehicle V, provides the map information MI on the surroundings of a traveling position of the own vehicle V, and guides the own vehicle V along the determined traveling route RA. The area information extractor 112 extracts the communication difficulty area WR which is an area in which a communication state is deteriorated. The communication difficulty area WR is included in the map information. The vehicle controller 130 performs the traveling auxiliary control DA including the automated driving in which a driving operation to drive the own vehicle is to be performed primarily by the own vehicle V, or the driver assistance in which a driving operation primarily performed by a driver is to be assisted. The travel information manager 113 determines the communication state TS in the traveling direction of the own vehicle V based on the information received from the area information extractor 112 and transmits travel information DI on the own vehicle V to the vehicle controller 130 based on the traveling mode DM selected in the vehicle controller 130. When the travel information manager 113 determines that the own vehicle V is to travel in the communication difficulty area WR or that the communication difficulty area WR is located on the determined traveling route RA, the travel information manager 113 transmits, to the vehicle controller 130, the information indicating that the traveling mode DM is to be switched to the power-saving traveling mode ED in which the electric power consumption of an electrical device in the own vehicle Vis reduced, and the vehicle controller 130 switches the traveling mode DM to the power-saving traveling mode ED, stops the map information MI for the traveling auxiliary control DA from being updated via communication, and performs the traveling auxiliary control DA based on the map information MI acquired before the entry of the own vehicle V into the communication difficulty area WR.

That is, when determining that the own vehicle V is to travel in the communication difficulty area WR or that the communication difficulty area WR is located on the traveling route RA, the travel information manager 113 automatically switches the traveling mode DM to the power-saving traveling mode ED in which the electric power consumption is reduced.

It is therefore possible to reduce the electric power consumption of the vehicle traveling battery of the own vehicle without making the occupant conscious of the switch to the power-saving traveling mode ED.

Further, the vehicle controller 130 keep performing the traveling auxiliary control DA using the map information MI used immediately before the entry of the own vehicle V in the communication difficulty area WR. It is therefore possible to reduce the electric power consumption of the vehicle traveling battery BT of the own vehicle without making the occupant conscious of the stop of the update of the map information MI.

It is therefore possible to reduce the electric power consumption of the vehicle traveling battery BT without making the occupant feel strange when the own vehicle V enters the communication difficulty area WR.

Further, when the own vehicle V travels in the communication difficulty area WR with the power-saving traveling mode ED being selected, the travel information manager 113 of the in-vehicle apparatus 10 according to the first embodiment causes the navigator 111 and the vehicle controller 130 to set the power-saving traveling route RE in view of the undulations of the determined traveling route RA and the number of traffic lights on the determined traveling route RA.

That is, when the own vehicle travels in the communication difficulty area WR with the power-saving traveling mode ED being selected, the travel information manager 113 may switch the traveling route RA to the power-saving traveling route RE on which the acceleration/deceleration control of the own vehicle V is less likely to be performed if it is possible to select the power-saving traveling route RE from the multiple potential traveling routes.

It is therefore possible to reduce the electric power consumption of the vehicle traveling battery BT of the own vehicle V without making the occupant conscious of the switch to the power-saving traveling route RE.

It is therefore possible to reduce the electric power consumption of the vehicle traveling battery BT without making the occupant feel strange when the own vehicle V enters the communication difficulty area WR.

### Second Embodiment

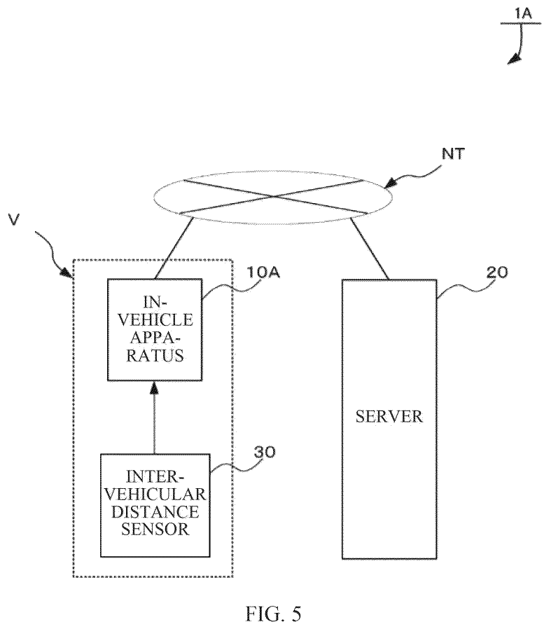

An in-vehicle apparatus 10A according to a second embodiment will now be described with reference to FIGS. 5 to 7.

Note that configuration elements denoted by the same reference numerals as those in the first embodiment have similar functions to those in the first embodiment, and detailed descriptions thereof are thus omitted.

### <Vehicle Control System 1>

As illustrated in FIG. 5, a vehicle control system 1A in which the in-vehicle apparatus 10A according to the second embodiment is mounted includes the in-vehicle apparatus 10A, the server 20, and an inter-vehicular distance sensor 30.

The inter-vehicular distance sensor 30 is provided on a vehicle frontal portion of the own vehicle V, and acquires an inter-vehicular distance between the own vehicle V and another vehicle traveling in front of the own vehicle V. The inter-vehicular distance sensor 30 is a millimeter-wave radar sensor or an optical camera sensor. The inter-vehicular distance sensor 30 acquires the inter-vehicular distance, a relative speed, an angle, and a brake lamp operation to the other vehicle traveling in front of the own vehicle V. The information acquired by the inter-vehicular distance sensor 30 is transmitted to the vehicle controller 130B.

### <Configuration of In-Vehicle Apparatus 10A>

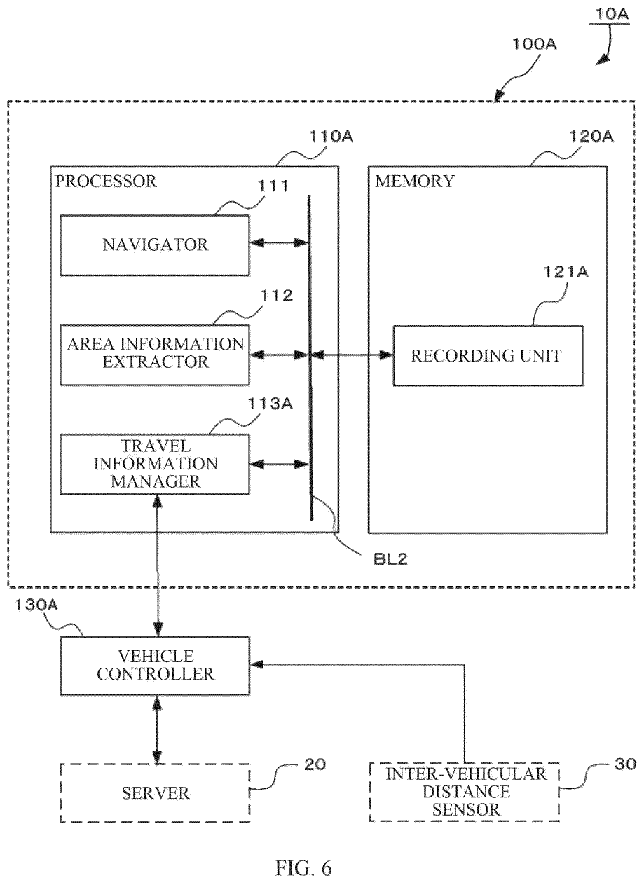

As illustrated in FIG. 6, the in-vehicle apparatus 10A includes a processor 110A, a memory 120A, and a vehicle controller 130A.

### <Configuration of Processor Unit 100A>

The processor unit 100A includes a processor 110A and a memory 120A. The processor unit 100A controls an overall operation of the in-vehicle apparatus 10A based on a control program stored in a read-only memory (ROM) included in the memory 120A.

The processor 110A includes the navigator 111, the area information extractor 112, and a travel information manager 113A. The memory 120A includes a recording unit 121A.

The navigator 111, the area information extractor 112, and the travel information manager 113A in the processor 110A, and the memory 120A are coupled to each other via a bus line BL2.

When the own vehicle V enters the communication difficulty area WR and travels in the communication difficulty area WR with the power-saving traveling mode ED being selected, the travel information manager 113A transmits, to the vehicle controller 130A, information indicating that a normal following traveling mode in which the own vehicle V travels following a preceding vehicle FV traveling in front of the own vehicle V while maintaining a constant inter-vehicular distance is to be switched to a power-saving following traveling mode in which the own vehicle V travels following the preceding vehicle FV while maintaining a longer inter-vehicular distance than that in the normal following traveling mode.

Based on the information received from the travel information manager 113A, the vehicle controller 130A automatically switches the normal following traveling mode to the power-saving following traveling mode, performs gradual acceleration/deceleration control in which the electric power consumption is reduced when the own vehicle V travels following the preceding vehicle FV, and performs control to maintain a longer inter-vehicular distance than that in the normal following traveling mode.

### <Process in In-Vehicle Apparatus 10A>

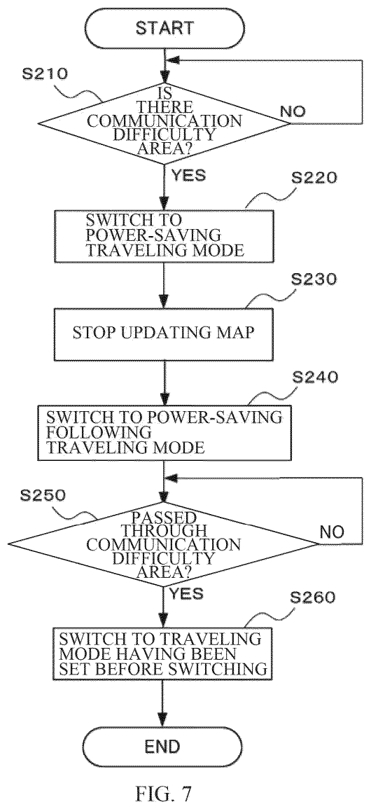

The in-vehicle apparatus 10A according to the second embodiment will now be described with reference to FIG. 7.

The travel information manager 113A determines whether the communication difficulty area is located in the traveling direction of the own vehicle V or on the traveling route RA based on the information received from the area information extractor 112 (Step S210).

When determining that the communication difficulty area WR is not located on the traveling route RA or in the traveling direction of the own vehicle V (Step S210: NO), the travel information manager 113A causes the process to transit to Step S210.

In contrast, when determining that the communication difficulty area WR is located in the traveling direction of the own vehicle V or on the traveling route RA (Step S210: YES), the travel information manager 113A transmits the information indicating that the traveling mode DM is to be switched to the power-saving traveling mode ED to the vehicle controller 130A. Based on the information received from the travel information manager 113A, the vehicle controller 130A switches the control in the traveling mode MD to the control in the power-saving traveling mode ED (Step S220), and the travel information manager 113A causes the process to transit to Step S230.

Further, the vehicle controller 130A stops the map information from being updated via the communication, and starts the traveling auxiliary control DA based on the map information MI acquired before the entry of the own vehicle V in the communication difficulty area WR (Step S130).

The travel information manager 113A transmits the information indicating that the normal following traveling mode is to be switched to the power-saving following traveling mode to the vehicle controller 130A.

Based on the information received from the travel information manager 113A, the vehicle controller 130A switches the normal following traveling mode to the power-saving following traveling mode (Step S240).

Thereafter, the travel information manager 113A determines whether the own vehicle V has passed through the communication difficulty area WR based on the information received from the area information extractor 112 (Step S250).

When determining that the own vehicle V has not passed through the communication difficulty area WR (Step S250: NO), the travel information manager 113A causes the process to transit to Step S250.

In contrast, when determining that the own vehicle V has passed through the communication difficulty area WR (Step S250: YES), the travel information manager 113A transmits the information indicating that the own vehicle V has passed through the communication difficulty area WR to the vehicle controller 130A, and causes the process to transit to Step S260.

Based on the information received from the travel information manager 113A, the vehicle controller 130A switches the power-saving traveling mode ED to the traveling mode DM having been selected before the entry of the own vehicle V into the communication difficulty area WR (Step S260), and the travel information manager 113 terminates the process.

### <Workings and Effects>

As described above, the in-vehicle apparatus 10A according to the second embodiment further includes the inter-vehicular distance sensor 30 that acquires the inter-vehicular distance to the preceding vehicle FV traveling in front of the own vehicle V. When the own vehicle V travels in the communication difficulty area WR with the power-saving traveling mode ED being selected, the travel information manager 113A transmits, to the vehicle controller 130A, the information indicating that the normal following traveling mode in which the own vehicle V travels following the preceding vehicle FV while maintaining a constant inter-vehicular distance is to be switched to the power-saving following traveling mode in which the own vehicle V travels following the preceding vehicle FV while maintaining a longer inter-vehicular distance than that in the normal following traveling mode, and the vehicle controller 130A performs the control to maintain the inter-vehicular distance by performing the gradual acceleration/deceleration control on the own vehicle V traveling following the preceding vehicle FV.

That is, when the own vehicle V travels in the communication difficulty area WR with the power-saving traveling mode ED being selected, the vehicle controller 130A automatically switches the power-saving traveling mode ED to the power-saving following traveling mode. This enables the vehicle controller 130A to perform the acceleration/deceleration control in which the electric power consumption is reduced, and perform the traveling auxiliary control DA in which a longer inter-vehicular distance is maintained than that in the normal following traveling mode. It is therefore possible to reduce the electric power consumption of the vehicle traveling battery of the own vehicle V without making the occupant conscious of the switch to the power-saving following traveling mode.

It is therefore possible to reduce the electric power consumption of the vehicle traveling battery BT without making the occupant feel strange when the own vehicle V enters the communication difficulty area WR.

### Third Embodiment

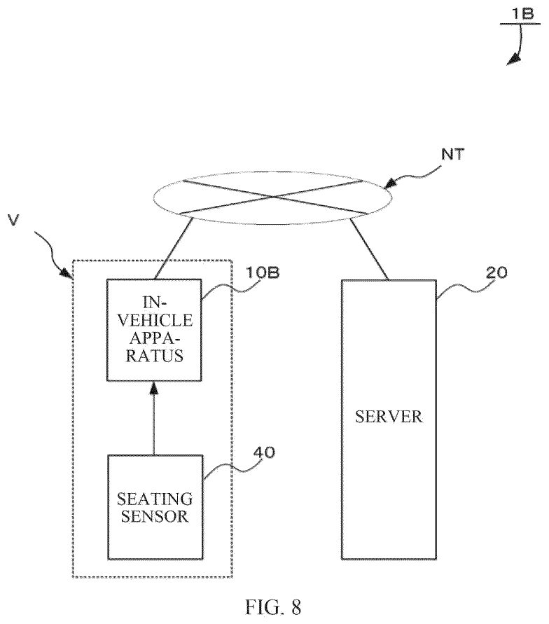

An in-vehicle apparatus 10B according to a third embodiment will now be described with reference to FIGS. 8 to 10.

Note that configuration elements denoted by the same reference numerals as those in the first and second embodiments have similar functions to those in the first and second embodiments, and detailed descriptions thereof are thus omitted.

### <Vehicle Control System 1B>

As illustrated in FIG. 8, a vehicle control system 1B including the in-vehicle apparatus 10B according to the third embodiment includes the in-vehicle apparatus 10B, the server 20, and a seating sensor 40.

The seating sensor 40 is provided inside a seat cushion disposed on a lower side of a non-illustrated seat of the vehicle. For example, the seating sensor 40 is a weight sensor that detects a weight applied to the seat cushion.

The seating sensor 40 is provided for each seat disposed in the own vehicle V. The seating sensor 50 acquires information on the weight applied to the seat cushion, and transmits the information on the weight for each seat to the vehicle controller 130B.

### <Configuration of In-Vehicle Apparatus 10B>

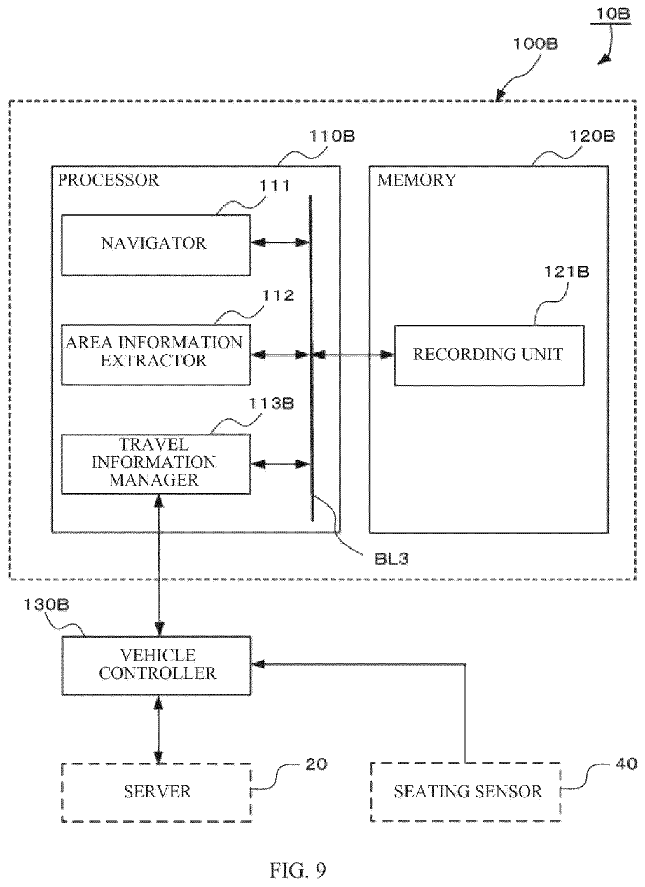

As illustrated in FIG. 9, the in-vehicle apparatus 10B includes a processor 110B, a memory 120B, and the vehicle controller 130B.

### <Configuration of Processor Unit 100B>

The processor unit 100B includes a processor 110B and a memory 120B. The processor unit 100B controls an overall operation of the in-vehicle apparatus 10B based on a control program stored in a read-only memory (ROM) included in the memory 120B.

The processor 110B includes the navigator 111, the area information extractor 112, and a travel information manager 113B. The memory 120B includes a recording unit 121B.

The navigator 111, the area information extractor 112, and the travel information manager 113B in the processor 110B, and the memory 120 are coupled to each other via a bus line BL3.

When the own vehicle V enters the communication difficulty area WR and travels in the communication difficulty area WR with the power-saving traveling mode ED being selected, the travel information manager 113B transmits, to the vehicle controller 130B, information indicating that an air flow of the air conditioner toward a position in which no occupant is seated is to be reduced or stopped.

Based on the information on the weight received from the seating sensor 40, the vehicle controller 130B transmits information on a position in which an occupant is seated to the travel information manager 113B. Based on the information received from the travel information manager 113B, the vehicle controller 130 performs control in which the air flow of the air conditioner toward the seat in which no occupant is seated is automatically adjusted to reduce or stop the air flow of the air conditioner.

### <Process in In-Vehicle Apparatus 10B>

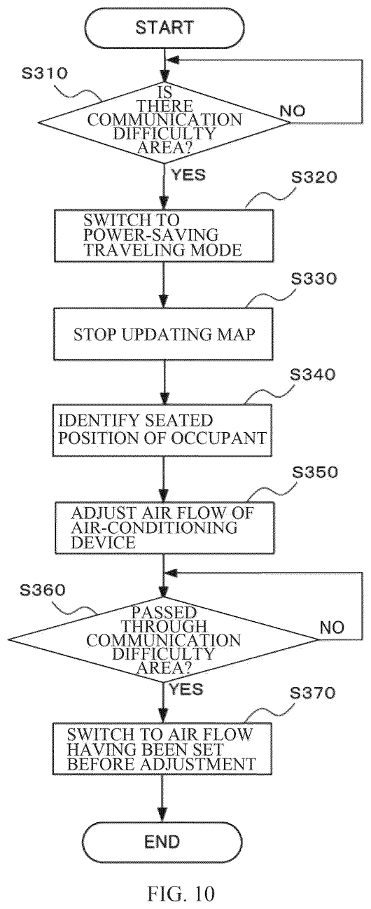

The in-vehicle apparatus 10B according to the third embodiment will now be described with reference to FIG. 10.

The travel information manager 113B determines whether the communication difficulty area is located in the traveling direction of the own vehicle V or on the traveling route RA based on the information received from the area information extractor 112 (Step S310).

When determining that the communication difficulty area WR is not located on the traveling route RA or in the traveling direction of the own vehicle V (Step S310: NO), the travel information manager 113B causes the process to transit to Step S310.

In contrast, when determining that the communication difficulty area WR is located in the traveling direction of the own vehicle V or on the traveling route RA (Step S310: YES), the travel information manager 113B transmits the information indicating that the traveling mode DM is to be switched to the power-saving traveling mode ED to the vehicle controller 130B. Based on the information received from the travel information manager 113B, the vehicle controller 130B switches the control in the traveling mode MD to the control in the power-saving traveling mode ED (Step S320), and the travel information manager 113B causes the process to transit to Step S330.

Further, the vehicle controller 130B stops the map information from being updated via the communication, and starts the traveling auxiliary control DA based on the map information MI acquired before the entry of the own vehicle V into the communication difficulty area WR (Step S330).

Further, the vehicle controller 130B transmits the information on the position of the seat in which the occupant is seated to the travel information manager 113B, and the travel information manager 113B determines the position of the seat in which the occupant is seated (Step S340).

The travel information manager 113B transmits the information indicating that the air flow of the air conditioner toward the seat in which no occupant is seated is to be reduced or stopped to the vehicle controller 130B.

Based on the information received from the travel information manager 113B, the vehicle controller 130 performs control in which the air flow of the air conditioner toward the seat in which no occupant is seated is adjusted to reduce or stop the air flow of the air conditioner (Step S350).

Thereafter, the travel information manager 113B determines whether the own vehicle V has passed through the communication difficulty area WR based on the information received from the area information extractor 112 (Step S360).

When determining that the own vehicle V has not passed through the communication difficulty area WR (Step S360: NO), the travel information manager 113B causes the process to transit to Step S360.

In contrast, when determining that the own vehicle V has passed through the communication difficulty area WR (Step S250: YES), the travel information manager 113 transmits the information indicating that the own vehicle V has passed through the communication difficulty area WR to the vehicle controller 130B, and causes the process to transit to Step S260.

Based on the information received from the travel information manager 113B, the vehicle controller 130B changes the air flow of the air conditioner to the air flow having been set before the entry of the own vehicle V into the communication difficulty area WR (Step S370), and the travel information manager 113B terminates the process.

### <Workings and Effects>

As described above, the in-vehicle apparatus 10B according to the third embodiment further includes the seating sensor 40 that detects the position in the own vehicle V in which the occupant is seated. When the own vehicle V travels in the communication difficulty area WR with the power-saving traveling mode ED being selected, the travel information manager 113B transmits, to the vehicle controller 130B, the information indicating that the air flow of the air conditioner toward the position in which no occupant is seated is to be reduced or stopped.

That is, when the own vehicle V travels in the communication difficulty area WR with the power-saving traveling mode ED being selected, the vehicle controller 130B performs the control in which the air flow of the air conditioner toward the seat in which no occupant is seated is automatically reduced or stopped. It is therefore possible to reduce the electric power consumption of the vehicle traveling battery of the own vehicle V without making the occupant conscious of the adjustment of the air conditioner.

It is therefore possible to reduce the electric power consumption of the vehicle traveling battery BT without making the occupant feel strange when the own vehicle V enters the communication difficulty area WR.

Note that the travel information managers 113 to 113B may each simultaneously perform all of the control to cause the navigator 111 to select the power-saving traveling route RE, the control to cause the vehicle controllers 130 to 130B to select the power-saving traveling mode ED, and the control to cause the vehicle controllers 130 to 130B to reduce or stop the air flow toward the seat in which no occupant is seated.

Further, it is possible to implement the in-vehicle apparatuses 10 to 10B of the invention by recording the process to be executed by the processors 110 to 110B on a recording medium readable by a computer system, and causing the computer system to load the program recorded on the recording medium onto the processors 110 to 110B to execute the program. The computer system as used herein may encompass an operating system (OS) and hardware such as a peripheral device. The computer system as used herein may encompass an operating system (OS) and hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program refers to a medium having a capability to transmit data, including a network (e.g., a communication network) such as the Internet and a communication link (e.g., a communication line) such as a telephone line.

Further, the program may be directed to implement a part of the operation described above. The program may be a so-called differential file (differential program) configured to implement the operation by a combination of a program already recorded on the computer system. The program may be a so-called differential file (differential program) configured to implement the operation by a combination of a program already recorded on the computer system.

Although some embodiments of the invention have been described in detail with reference to the accompanying drawings, the configuration is not particularly limited to these embodiments, and may include designs and the like within a range not departing from the gist of the invention.

### DESCRIPTION OF REFERENCE NUMERALS

1: Vehicle control system
1A: Vehicle control system
1B: Vehicle control system
10: In-vehicle apparatus
10A: In-vehicle apparatus
10B: In-vehicle apparatus
20: Server
110: Processor
110A: Processor
110B: Processor
111: Navigator
112: Area information extractor
113: Travel information manager
113A: Travel information manager
113B: Travel information manager
120: Memory
120A: Memory
120B: Memory
121: Recording unit
121A: Recording unit
121B: Recording unit
130: Vehicle controller
DI: Travel information
DM: Traveling mode
ED: Power-saving traveling mode
RA: Traveling route
WD: Communication difficulty area traveling distance
WP1: Communication difficulty area entrance point
WR: Communication difficulty area

1. An in-vehicle apparatus comprising:
a navigator configured to acquire a current position of an own vehicle, provide map information on surroundings of the current position of the own vehicle, and guide the own vehicle along a determined traveling route;
an area information extractor configured to extract an area in which a communication state is deteriorated, the area being included in the map information;
a vehicle controller configured to perform traveling auxiliary control comprising automated driving in which a driving operation to drive the own vehicle is to be performed primarily by the own vehicle or driver assistance in which a driving operation primarily performed by a driver is to be assisted; and
a travel information manager configured to determine the communication state in a traveling direction of the own vehicle based on information received from the area information extractor and transmit travel information on the own vehicle to the vehicle controller based on a traveling mode selected in the vehicle controller, wherein,
the travel information manager is configured to, when the travel information manager determines that the own vehicle is to travel in the area in which the communication state is deteriorated or that the area in which the communication state is deteriorated is located on the determined traveling route, transmit, to the vehicle controller, information indicating that the traveling mode is to be switched to a power-saving traveling mode in which electric power consumption of an electrical device in the own vehicle is reduced, and
the vehicle controller is configured to switch the traveling mode to the power-saving traveling mode, stop the map information for the traveling auxiliary control from being updated via communication, and perform the traveling auxiliary control based on the map information acquired before entry of the own vehicle into the area in which the communication state is deteriorated.

2. The in-vehicle apparatus according to claim 1, wherein the travel information manager is configured to, when the own vehicle travels in the area in which the communication state is deteriorated with the power-saving traveling mode being selected, cause the navigator and the vehicle controller to set the traveling route on which acceleration and deceleration control on the own vehicle is less likely to be performed in view of undulations of the traveling route and a number of traffic lights on the traveling route.

3. The in-vehicle apparatus according to claim 2, wherein the own vehicle further comprises an inter-vehicular distance sensor configured to acquire an inter-vehicular distance to a preceding vehicle traveling in front of the own vehicle, and
the travel information manager is configured to,
when the own vehicle travels in the area in which the communication state is deteriorated with the power-saving traveling mode being selected,
transmit, to the vehicle controller, information indicating that a normal following traveling mode is to be switched to a power-saving following traveling mode, the normal following traveling mode being a mode in which the own vehicle travels following the preceding vehicle while maintaining a constant inter-vehicular distance based on information received from the inter-vehicular distance sensor, the power-saving following traveling mode being a mode in which the own vehicle travels following the preceding vehicle while maintaining a longer inter-vehicular distance than the inter-vehicular distance in the normal following traveling mode, and
the vehicle controller is configured to perform control to maintain the inter-vehicular distance by performing gradual acceleration and deceleration control upon following the preceding vehicle.

4. The in-vehicle apparatus according to claim 2, wherein
the own vehicle further comprises a seating sensor configured to detect a position in which an occupant of the own vehicle is seated,
the travel information manager is configured to,
when the own vehicle travels in the area in which the communication state is deteriorated with the power-saving traveling mode being selected, transmit, to the vehicle controller, information indicating that an air flow of an air conditioner toward a seat in which no occupant is seated is to be reduced or stopped.

5. An in-vehicle apparatus comprising:
one or more processors; and
one or memories communicably coupled to the one or more processors,
the one or more memories comprising a recording unit that records map information on routes and information on an area in which a communication state is deteriorated,
the one or more processors comprising
a navigator configured to acquire a current position of an own vehicle, provide map information on surroundings of the current position of the own vehicle, and guide the own vehicle along a determined traveling route,
an area information extractor configured to extract the area in which the communication state is deteriorated, the area being included in the map information,
a vehicle controller configured to perform traveling auxiliary control comprising automated driving in which a driving operation to drive the own vehicle is to be performed primarily by the own vehicle or driver assistance in which a driving operation primarily performed by a driver is to be assisted, and
a travel information manager configured to determine the communication state in a traveling direction of the own vehicle based on information received from the area information extractor, manages travel information on the own vehicle based on a traveling mode selected in the vehicle controller, and transmits the travel information to the vehicle controller based on a request from the vehicle controller, wherein,
the travel information manager is configured to, when the travel information manager determines that the own vehicle is to travel in the area in which the communication state is deteriorated or that the area in which the communication state is deteriorated is located on the determined traveling route, transmit, to the vehicle controller, information indicating that the traveling mode is to be switched to a power-saving traveling mode in which electric power consumption of an electrical device in the own vehicle is reduced, and
the vehicle controller is configured to switch the traveling mode to the power-saving traveling mode, stops the map information for the traveling auxiliary control from being updated via communication, and performs the traveling auxiliary control based on the map information acquired before entry of the own vehicle into the area in which the communication state is deteriorated.
